(19) United States
(12) Patent Application Publication
(10) Pub. No.: US 2002/0170324 A1
(43) Pub. Date: Nov. 21, 2002

(54) Bicycle lock device with retractable cable

(76) Inventor: John H. Wilson, Deerfield Beach, FL (US)

Correspondence Address: JOHN H. OLTMAN, Suite 415, 915 Middle River Drive, Ft. Lauderdale, FL, 33304, US

(21) Appl. No.: 09/861,992

(22) Filed: May 21, 2001

(51) Int. Cl. E05B 71/00

(52) U.S. Cl. 70/233

(57) ABSTRACT

A bicycle lock device with a housing holding an extensible and retractable cable on a spring-biased reel. The bias spring for the reel is substantially sealed, and the interior of the housing is open to the outside at only one opening, through which the cable passes. The cable may be pulled out from the housing to position its outer end between laterally spaced, outwardly projecting ears on the outside of the housing, with an opening at the outer end of the cable registering with openings in these ears for the attachment of a padlock. Additional projections are provided on the outside of the housing for attaching it to different parts of a bicycle frame.

### BACKGROUND OF THE INVENTION

1. Field of the Invention

This invention relates to a lock device for a bicycle, motorcycle or the like with a reel-mounted extensible and retractable cable.

2. Prior Art

Various bicycle cable locks have been proposed heretofore which have a cable wound on a spring-retractable reel inside a housing, with the outer end of the cable carrying means for locking engagement in the housing when the cable is extended from the housing by unwinding it from the reel. The following U.S. patents show arrangements of this general type: Hurwitt U.S. Pat. No. 3,906,758, Foster et al U.S. Pat. No. 4,086,795, Green U.S. Pat. No. 4,404,822, and Papandrea et al U.S. Pat. No. 4,543,806.

Other bicycle cable locks have been proposed in which a padlock holds the outer end of a reel-wound cable to lock the cable in an extended position partially unwound from the reel inside a housing. Ray U.S. Pat. No. 4,037,441 and Timmons et al U.S. Pat. No. 4,126,024 show arrangements of this general type. In Timmons et al the cable has looped opposite ends to which the padlock is applied outside the housing for retracting the extended cable. At one end the cable passes out of the housing through the open end of a rotatable cylinder which carries the reel and is positioned centrally of the housing. A torsion spring inside the housing has its inner end anchored in this cylinder and exposed to the open end of the cylinder.

### SUMMARY OF THE INVENTION

The present invention is directed to a novel cable lock device for bicycles and the like in which, in the preferred embodiment, a cable reel and a torsion spring biasing the reel in one rotational direction are positioned in separate side-by-side compartments of a housing, with the spring compartment essentially completely sealed and the reel compartment having just one opening, for passing the cable. The cable has an opening at its outer end, and the housing at one circumferential location thereon has laterally spaced, outwardly projecting ears with openings therein for the attachment of a padlock to these ears and to the outer end of the cable at the respective openings therein.

A principal object of this invention is to provide a novel bicycle lock device of simplified construction whose operating parts are more effectively protected from dirt, water and the like.

Another object of this invention is to provide a novel lock device with a housing carrying a reel-mounted extensible and retractable cable having an opening at its outer end for registration with one or more openings on the outside of the housing to receive a padlock. Preferably, laterally spaced ears on the outside of the housing at one peripheral location receive the outer end of the cable between them and present openings for registration with the opening at the outer end of the cable to receive the padlock.

Another object of this invention is to provide a novel lock device with a housing carrying a reel-mounted extensible and retractable cable and having a novel arrangement on the outside for mounting it on different parts of a bicycle frame.

Further objects and advantages of the invention will be apparent from the following detailed description of a presently preferred embodiment thereof, illustrated in the accompanying drawings.

### BRIEF DESCRIPTION OF THE DRAWINGS

FIG. 1 is a front elevation of the present lock device with the cable retracted;

FIG. 2 is a top plan view of the lock device shown in FIG. 1, omitting the outer end of the cable;

FIG. 3 is a bottom plan view of the FIG. 1 lock device, with the outer end of the cable omitted;

FIG. 4 is an end view taken from the left side of the lock device in FIG. 1, with the outer end of the cable omitted;

FIG. 5 is a longitudinal vertical cross-section taken along the line 5-5 in FIG. 2 and showing the cable wound on a rotatable reel inside the housing of the lock device;

FIG. 6 shows the lock device mounted on the frame of a bicycle and shows the interior of its housing along the longitudinal vertical section line 6-6 in FIG. 2, where the torsion spring for retracting the cable is located;

FIG. 7 is a vertical cross-section taken along the line 7-7 in FIG. 1 and showing a padlock locking the outer end of the extended cable to the housing of the lock device; and

FIG. 8 shows the present lock device mounted on a bicycle with the cable extended from housing of the lock device and wrapped around a tree, and its outer end locked to the outside of the lock device housing by a padlock.

### DETAILED DESCRIPTION OF THE INVENTION

Before explaining the present invention in detail it is to be understood that the invention is not limited in its application to the particular arrangement shown and described herein since the invention is capable of other embodiments. Also, the terminology used herein is for the purpose of description and not of limitation.

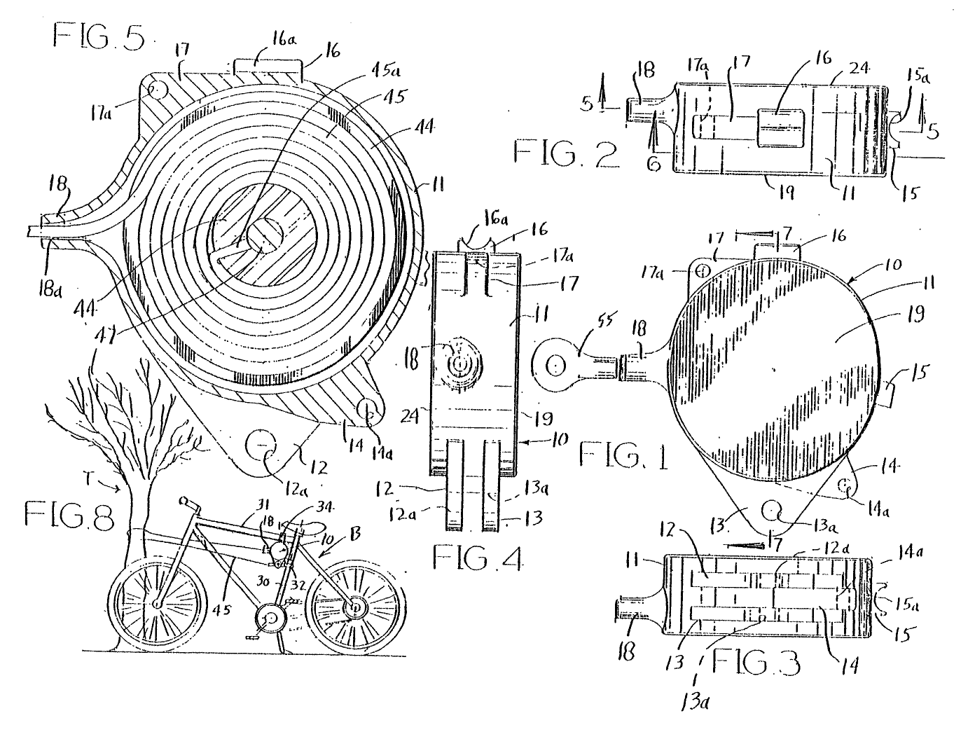

Referring to FIG. 1, the cable lock of the present invention comprises a housing 10 having a peripheral side wall 11 (FIG. 5) which is cylindrical for most of its extent circumferentially. At the bottom in FIG. 1 the housing presents laterally spaced, parallel, flat ears 12 and 13 (FIG. 4) which are integral with side wall 11 and project out from it. These ears present aligned openings 12a and 13a.

Also at the bottom in FIG. 1 the housing presents an outwardly projecting flat ear 14 (FIGS. 1, 3 and 4) which is integral with the peripheral side wall 11 and is located between the lower ears 12 and 13 and extends to the right of them in FIG. 1. Ear 14 is formed with an opening 14a. A short distance upward from the ear 14 in FIG. 1 the housing presents a projection 15 channel-shaped cross-section (FIGS. 1 and 2) which is integral with the housing side wall 11 and presents a concave outer surface 15a. A similar channel-shaped projection 16 (FIGS. 1, 2 and 4) formed integral with the peripheral side wall 11 of the housing is located at the top of the housing in FIG. 1, and it presents a concave outer surface 16a (FIG. 4). A slightly thinner, outwardly projecting, flat ear 17 (FIGS. 1, 2 and 5) extends to the left of the top projection 16 and presents an opening 17a.

At its left end in FIG. 1 the housing presents an annular neck 18 of gradually decreasing diameter projecting out from its peripheral side wall 11 and formed integral with it. Neck 18 defines a circular opening 18a (FIG. 5) of correspondingly decreasing diameter outward from the side wall 11.

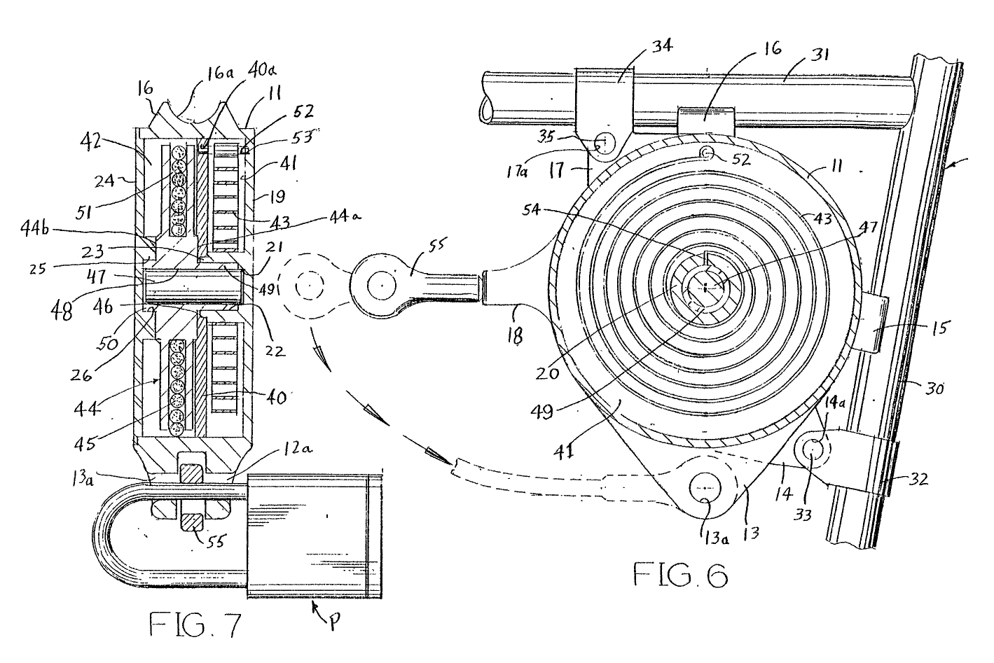

The housing 10 is of two-piece construction, one piece of which provides the generally cylindrical peripheral side wall 11, the outwardly projecting ears 12, 13, 14 and 17, and the channel-shaped projections 15 and 16, and also a flat end wall 19 (FIG. 7) to which is joined an inwardly projecting, centrally located, annular socket 20. Socket 20 presents a cylindrical bore 21 next to the end wall 19, a cylindrical counterbore 22 inward from bore 21, and a short cylindrical segment 23 of smaller outside diameter at its inner end. The inner end of socket 20 is about half-way across the axial extent of the peripheral side wall 11. The second piece of housing 10 comprises a flat end wall 24 (FIG. 7) with an inwardly projecting, centrally located, cylindrical segment 25 that defines a cylindrical recess 26 coaxial with bore 21 and counterbore 22 of the inwardly projecting socket 20 on the other piece of the housing. The end wall 24 of the second piece of housing 10 is secured in air-tight and liquid-tight fashion to the peripheral side wall 11 of the first piece of the housing.

As shown in FIG. 6, the channel-shaped projections 15 and 16 which are spaced apart circumferentially on the outside of housing 10 are positioned and shaped for snug engagement respectively with a downwardly extending part 30 and with a substantially horizontal part 31 of the frame F of a bicycle B (FIG. 8). The lower ear 14 on housing 10 is attachable to the downwardly extending bicycle frame part 30 by a clamp 32 of known design that substantially encircles the frame part 30 and is pivotally coupled to ear 14 by a cross pin 33 extending through the opening 14a in the latter. Similarly, the ear 17 at the upper front of housing 10 is attached to the substantially horizontal part 31 of the bicycle frame by a clamp 34 that substantially encircles the frame part 31 and is pivotally coupled to ear 17 by a cross pin 35 extending through the latter's opening 17a.

As shown in FIG. 7, a thin flat plate 40 divides the interior of housing 10 into two side-by-side chambers 41 and 42 for respectively receiving a spiral-wound torsion spring 43 and a reel 44 with several turns of a cable 45 wound on it. The is no opening in housing 10 leading into the spring chamber 41, and there is only the single opening 18a leading from the cable reel chamber 42. The separator plate 40 has a circular, stepped central opening 46 that snugly receives the reduced inner end segment 23 of the housing socket 20 and abuts against its end face to securely position the separator plate in the housing. The periphery of separator plate 40 snugly engages the inside of the housing's peripheral side wall 11 about half-way across the axial depth of the housing. An opening 40a is formed in separator plate 40 a short distance in from its periphery.

A shaft 47 is press-fitted into the bore 21 in the housing end wall 19 to provide a stationary axis on which the cable reel 44 rotates. The reel is formed with a cylindrical central opening 48 which has a rotatable fit on the fixed shaft 47. On the right side in FIG. 7 the cable reel present a cylindrical sleeve 49 with a rotatable fit in the counterbore 22 of the housing socket. On the opposite side the cable reel present a short cylindrical sleeve 50 that fits rotatably in recess 26 on the inside of the housing end wall 24.

Radially outward from its centrally located sleeves 49 and 50 the cable reel 44 presents flat, annular opposite faces 44a and 44b with a close sliding or running fit respectively against the separator plate 40 and the inner end face of the cylindrical segment 25 on the inside of housing end wall 24. Consequently, there is little chance for water, dirt or other foreign matter to get into areas in the housing where the reel is supported for rotation.

The cable reel presents a deep annular groove or recess 51 which receives successive turns of the cable 45. The inner end of the cable is anchored in the hub of the reel, as shown at 45a in FIG. 5. The outer turn of the cable passes out of housing chamber 42 through the housing opening 18a.

The torsion spring 43 at its outer end carries a cross pin 52 (FIG. 7) which is snugly received at one end in the opening 40a in separator plate 40 and at the opposite end in a complementary recess 53 in the housing end wall 19. Cross pin 52 attaches the outer end of spring to the housing. The inner end of spring 43 has a bent segment 54 (FIG. 6) which passes through an opening in socket 20 and is anchored in sleeve segment 49 of cable reel 43, so that when cable 45 is being unwound, causing the cable reel to turn in the corresponding direction, the spring 43 will be wound progressively more tightly and stressed torsionally.

In accordance with this invention a padlock-receiving opening is provided on the outer end of cable. This end of the cable may be formed into a loop to provide this opening but preferably the opening is provided by a metal eye 55 (FIGS. 1 and 6) affixed to the outer end of the cable. Normally, the torsion spring 43 positions the cable reel 44 in the rotational position in which the cable 45 is fully retracted into housing 10 and the eye 55 on its outer end abuts against the housing neck 18. By pulling on its outer end, the cable can be extended from the housing to a position as shown in FIG. 8, in which it is wrapped around a tree T or other fixed structure to which the bicycle is to be locked. The eye 55 on the outer end of cable 45 is positioned between the laterally spaced, aligned housing ears 12 and 13 (FIG. 7) with the opening in the eye registering with the openings 12a and 13a in these ears, after which a padlock P is inserted through the aligned openings to lock the outer end of cable 45 to the outside of housing 10.

When the user wants to unlock the bicycle, the padlock is removed, permitting the torsion spring 43 to turn the cable reel 44 in the direction for re-winding the cable 45 on the reel and retracting its outer end to the position shown in FIG. 1.

From the foregoing description, taken in conjunction with the accompanying drawings, it will be evident that the retraction spring 43 is completely protected from the elements—dirt, water, etc.—to insure a trouble-free, long life for the mechanism. Also the cable reel 44 has minimum exposure to the elements at the single opening 18a, and the chance of dirt, water or other foreign matter getting into the reel's rotating parts is minimized, as described. The laterally spaced ears 12 and 13 on the outside of the housing and the eye 55 on the outer end of the cable provide a convenient and effective arrangement to facilitate the attachment of a padlock to hold the cable in its extended position. The additional projections 15 and 16 and the adjacent ears 14 and 17 on the outside of the housing enable its attachment to different parts of a bicycle frame in a novel and effective manner.

I claim:

1. A bicycle lock device comprising:
a housing having a hollow interior and a single opening therein leading into said hollow interior;
a cable reel rotatably mounted in said interior of the housing and presenting means on which a cable may be wound;
a cable wound on said reel, said cable having an inner end thereof located inside said housing and affixed to said reel, said cable passing from said reel out through said opening and presenting an outer end outside said housing;
a spring in said interior of said housing biasing the reel in a rotational direction for winding said cable on the reel and retracting the outer end of the cable toward said opening in the housing;
said housing having an opening on the outside thereof;
and means on the outer end of said cable presenting an opening for registration with said opening on the outside of the housing to receive a padlock for locking the outer end of said cable to the outside of the housing.

2. A lock device according to claim 1 wherein said spring acts between said housing and said reel to urge said reel in said rotational direction, and further comprising a separator member inside said housing dividing the interior of said housing into a reel compartment holding said reel and communicating with said single opening leading into the interior of the housing and a spring compartment holding said spring and blocked by said separator member from said single opening leading into the interior of the housing.

3. A lock device according to claim 2 wherein said housing has at least one projection on the outside thereof, and said opening on the outside of the housing is in said projection.

4. A lock device according to claim 2 wherein said housing has a pair of outwardly projecting ears on the outside thereof which are laterally spaced apart to receive the outer end of said cable between them, said ears presenting aligned openings therein for registration with said opening in the outer end of the cable for the attachment of a padlock to said ears and to the outer end of the cable.

5. A bicycle lock device comprising:
a housing having a hollow interior and an opening therein leading into said hollow interior;
a cable reel rotatably mounted in said interior of the housing and presenting means on which a cable may be wound;
a cable wound on said reel, said cable having an inner end thereof affixed to said reel, said cable passing from said reel out through said opening and presenting an outer end outside said housing, and means on the outer end of said cable providing an opening;
a spring in said interior of said housing biasing the reel in a rotational direction for winding said cable on the reel and retracting the outer end of the cable toward said opening in the housing;
said housing having a pair of outwardly projecting ears on the outside thereof which are laterally spaced apart to receive the outer end of said cable between them, said ears presenting aligned openings therein for registration with said opening in the outer end of the cable for the attachment of a padlock to said ears and to the outer end of the cable.

6. A lock device according to claim 5 wherein said housing has additional projections on the outside thereof with outwardly-facing concave recesses for snug engagement with corresponding parts of the frame of a bicycle.

7. A bicycle lock device comprising:
a generally cylindrical housing having a hollow interior with a reel compartment and a spring compartment, and a separator plate in said housing between said compartments, said housing having only one opening therein communicating with its hollow interior, said opening leading from said reel compartment and being blocked from said spring compartment by said separator plate;
a cable reel rotatably mounted in said reel compartment and presenting means on which a cable may be wound;
a cable wound on said reel, said cable having an inner end thereof located inside said reel compartment and affixed to said reel, said cable passing from said reel out through said opening and presenting an outer end outside said housing, and means on the outer end of the cable providing an opening;
a spiral-wound torsion spring enclosed in said spring compartment of said housing and acting between said housing and said reel to bias the reel in a rotational direction for winding said cable on the reel and retracting the outer end of the cable toward said opening in the housing;
said housing having a pair of outwardly projecting ears on the outside thereof at one circumferential location which are laterally spaced apart to receive the outer end of said cable between them, said ears presenting aligned openings therein for registration with said opening in the outer end of the cable for receiving a padlock to attach the outer end of the cable to said ears on the housing;
said housing having additional projections on the outside thereof spaced apart circumferentially from said ears and from each other, said additional projections presenting outwardly-facing concave recesses for snug engagement with corresponding parts of the frame of a bicycle;
and said housing having additional outwardly projecting ears on the outside thereof located adjacent said additional projections and each having an opening therein for receiving a clamp to attach said housing of the lock device to a corresponding part of the bicycle frame.
